(19) United States
(12) Patent Application Publication
(10) Pub. No.: US 2021/0364888 A1
(43) Pub. Date: Nov. 25, 2021

(54) LENS APPARATUS, IMAGE PICKUP APPARATUS, AND CAMERA SYSTEM

(71) Applicant: CANON KABUSHIKI KAISHA, Tokyo (JP)

(72) Inventor: Yutaka Watanabe, Tochigi (JP)

(21) Appl. No.: 17/320,487

(22) Filed: May 14, 2021

(30) Foreign Application Priority Data
May 22, 2020 (JP) 2020-089680

(51) Int. Cl. G03B 17/14; G02B 7/02; G02B 7/09; G03B 13/36

(52) U.S. Cl. CPC G03B 17/14; G03B 13/36; G02B 7/09; G02B 7/021

(57) ABSTRACT

A lens apparatus is attachable to, detachable from, and communicable with the image pickup apparatus. The lens apparatus includes a focus lens configured to provide focusing, a driver configured to drive the focus lens, and at least one processor or circuit configured to execute a plurality of tasks configured to acquire first correction data for correcting an in-focus position, to maintain the first correction data when the focus lens is located in a first area where detecting reliability of the in-focus position by autofocus is high, and to change the first correction data to second correction data when the focus lens is located in a second area where the detecting reliability of the in-focus position by the autofocus is low.

### BACKGROUND OF THE INVENTION

### Field of the Invention

The present invention relates to a lens apparatus, an image pickup apparatus, and a camera system.

### Description of the Related Art

Conventionally, a lens interchangeable type camera system has been known which can capture an image while switching between an autofocus (AF) mode for providing automatic focusing using a focus detecting sensor in a camera, and a manual focus (MF) mode for providing manual focusing according to an operation of an operation unit by the user. Some interchangeable lenses in this camera system have an AF working area and an AF unworking area depending on the position of the focus lens. Japanese Patent Laid-Open No. (“JP”) 7-270672 discloses an AF apparatus that limits a moving range of a focus lens according to an F-number of a lens detected during the AF mode.

If the interchangeable lens has both the AF working area and the AF unworking area, the focus lens is located in the AF unworking area, and the AF is made according to the focus detecting sensor, accurate focusing may not be available. Therefore, the AF may be prohibited in the AF unworking area and the focus lens may be allowed to move only in the MF in the AF unworking area. However, in the AF on an object at an object distance corresponding to the AF working area while the focus lens is located in the AF unworking area, it is necessary to manually move the focus lens to the AF working area.

### SUMMARY OF THE INVENTION

The present invention provides a lens apparatus, an image pickup apparatus, and a camera system, each of which can smoothly start AF even when a focus lens is located in an AF unworking area.

A lens apparatus according to one aspect of the present invention is attachable to, detachable from, and communicable with the image pickup apparatus. The lens apparatus includes a focus lens configured to provide focusing, a driver configured to drive the focus lens, and at least one processor or circuit configured to execute a plurality of tasks configured to acquire first correction data for correcting an in-focus position, to maintain the first correction data when the focus lens is located in a first area where detecting reliability of the in-focus position by autofocus is high, and to change the first correction data to second correction data when the focus lens is located in a second area where the detecting reliability of the in-focus position by the autofocus is low.

The image pickup apparatus according to another aspect of the present invention includes at least one processor or circuit configured to execute a plurality of tasks configured to generate a signal relating to driving of the focus lens based on the first correction data when the first correction data is acquired from the lens apparatus, and to generate a signal relating to driving the focus lens based on the second correction data, when the second correction data is acquired from the lens apparatus.

A camera system according to another aspect of the present invention includes the above lens apparatus and the above image pickup apparatus.

Further features of the present invention will become apparent from the following description of exemplary embodiments with reference to the attached drawings.

### BRIEF DESCRIPTION OF THE DRAWINGS

FIG. 1 is a block diagram of a camera system according to one embodiment of the present invention.

FIG. 2 illustrates a communication circuit between a camera body and an interchangeable lens.

FIGS. 3A to 3C illustrate a communication waveform of a three-wire clock synchronous serial communication system.

FIG. 4 illustrates a movable range of a focus lens.

FIG. 5 illustrates a relationship between a defocus amount and in-focus position correction data.

FIGS. 6A and 6B illustrate an operation flow of reset (or recovery) operation processing of a focus lens.

### DESCRIPTION OF THE EMBODIMENTS

Referring now to the accompanying drawings, a detailed description will be given of embodiments according to the present invention. Corresponding elements in respective figures will be designated by the same reference numerals, and a duplicate description thereof will be omitted.

### Configuration

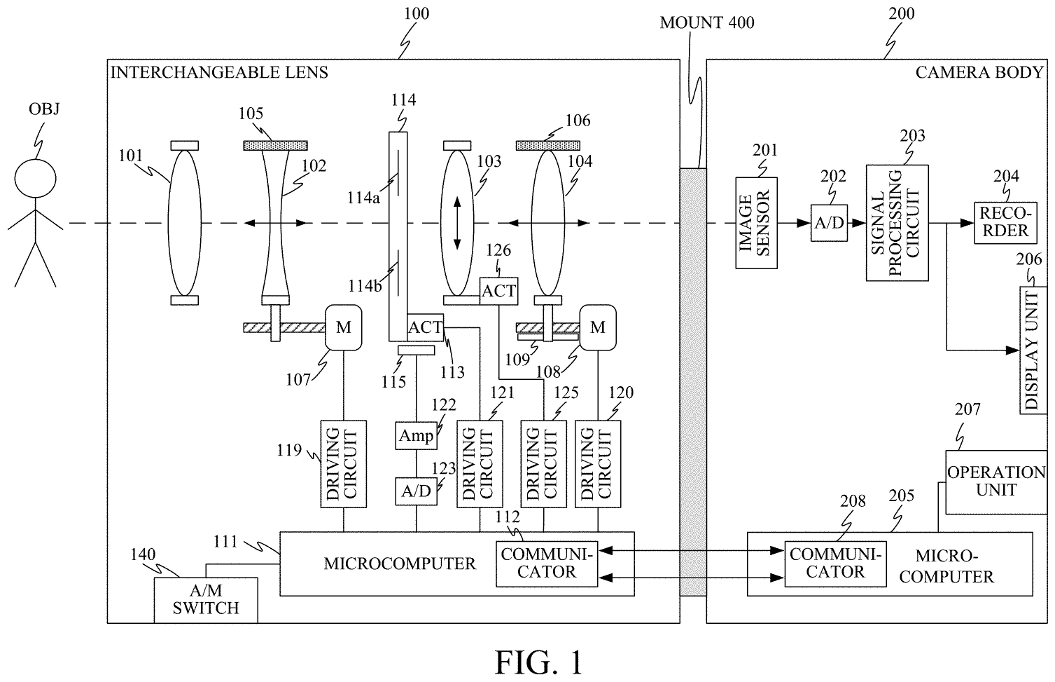

FIG. 1 is a block diagram of a camera system according to one embodiment of the present invention. The camera system includes a camera body (image pickup apparatus) 200 and an interchangeable lens 100 which is an illustrative accessory that is attachable to, detachable from, and communicable with the camera body 200.

The interchangeable lens 100 and the camera body 200 are mechanically and electrically connected via a mount 400, which is a connector mechanism. The interchangeable lens 100 receives power from the camera body 200 via an unillustrated power supply terminal provided on the mount 400, and controls various actuators and a lens microcomputer 111. The interchangeable lens 100 and the camera body 200 communicate with each other via a communication terminal provided on the mount 400.

A description will now be given of a configuration of the interchangeable lens 100. The interchangeable lens 100 has an imaging optical system. The imaging optical system includes, in order from an object OBJ side, a field lens 101, a magnification varying lens 102 configured to provide a magnification variation, a diaphragm (aperture stop) unit 114 configured to adjust a light amount, an image stabilizing lens 103, and a focus lens 104 configured to provide focusing.

The magnification varying lens 102 and the focus lens 104 are held by lens holding frames 105 and 106, respectively. Stepping motors (drivers) 107 and 108 drive the lens holding frames 105 and 106 along the optical axis of the imaging optical system illustrated by a broken line in synchronization with a driving pulse, respectively. A detector 109 detects the position of the focus lens 104 on the optical axis.

The image stabilizing lens 103 reduces an image blur caused by a camera shake or the like by moving in a direction orthogonal to the optical axis of the imaging optical system.

A lens microcomputer (processor, controller, lens controller) 111 controls the operation of each component in the interchangeable lens 100. The lens microcomputer 111 receives a control command transmitted from the camera body 200 via a lens communicator 112 and a transmission request command for requesting a transmission of lens data. When the control command is received, the lens microcomputer 111 provides a lens control corresponding to the control command. For example, the lens microcomputer 111 outputs a driving signal to a zoom driving circuit 119 and a focus driving circuit 120 to drive the stepping motors 107 and 108 in response to commands relating to a magnification variation and focusing among control commands. This configuration can perform zooming processing for controlling the magnification varying operation by the magnification varying lens 102 and AF processing for controlling a focusing operation by the focus lens 104. When receiving the transmission request command, the lens microcomputer 111 transmits the lens data corresponding to the transmission request command to the camera body 200 via the lens communicator 112.

The diaphragm unit 114 includes diaphragm blades 114a and 114b. A Hall element 115 detects the states of the diaphragm blades 114a and 114b. A detection result by the Hall element 115 is input to the lens microcomputer 111 via an amplifier circuit 122 and an A/D conversion circuit 123. The lens microcomputer 111 outputs a driving signal to a diaphragm driving circuit 121 based on the input signal from the A/D conversion circuit 123 to drive a diaphragm actuator 113. Thereby, the light amount adjusting operation is performed by the diaphragm unit 114.

The lens microcomputer 111 drives an image stabilizing actuator 126 via an image stabilization driving actuator 125 in response to the vibration detected by an unillustrated vibration sensor such as a vibration gyro provided in the interchangeable lens 100. Thereby, the image stabilizing processing that controls the shift operation of the image stabilizing lens 103 is performed.

A focus mode switch 140 switches a focus mode between an AF mode and an MF mode depending on its slide state.

The configuration of the camera body 200 will now be described below. The camera body 200 includes an image sensor 201 such as a CCD sensor or a CMOS sensor, an A/D conversion circuit 202, a signal processing circuit 203, a recorder 204, a camera microcomputer 205, a display unit 206, and an operation unit 207.

The image sensor 201 photoelectrically converts an object image formed by the imaging optical system in the interchangeable lens 100, and outputs an electric signal (analog signal). The image sensor 201 includes pixels for a focus detection and serves as a focus detecting sensor. The A/D conversion circuit 202 converts the analog signal from the image sensor 201 into a digital signal. The signal processing circuit 203 performs various image processing for the digital signal from the A/D conversion circuit 202 to generate a video signal.

The signal processing circuit 203 generates luminance information representative of the contrast state of the object image, that is, focus information indicative of a focus state and an exposure state of the imaging optical system from the video signal. The signal processing circuit 203 outputs the video signal to the display unit 206, which, in turn, displays the video signal as a live-view image used to check a composition, the focus state, and the like.

The operation unit 207 accepts the AF operation, release operation, and the like by the user.

The camera microcomputer (processor, controller, camera controller) 205 controls the camera body 200 in response to an input from the operation unit 207. The camera microcomputer 205 transmits a control command relating to the magnification varying operation of the magnification varying lens 102 to the lens microcomputer 111 in accordance with the operation of the zoom switch included in the operation unit 207 via the camera communicator 208. The camera microcomputer 205 transmits a control command relating to the light amount adjusting operation of the diaphragm unit 114 according to the luminance information and the focusing operation of the focus lens 104 according to the focus information to the lens microcomputer 111 via the camera communicator 208.

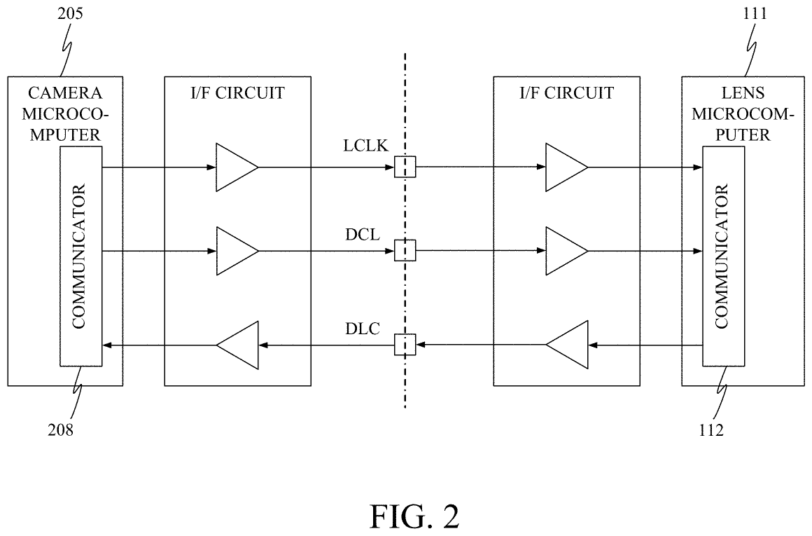

A description will be given of the communication circuits between the camera body 200 (camera microcomputer 205) and the interchangeable lens 100 (lens microcomputer 111) and the communication processing performed between them. FIG. 2 illuminates the communication circuits between the camera microcomputer 205 and the lens microcomputer 111.

The camera microcomputer 205 and the lens microcomputer 111 communicate with each other via the communication terminal provided to the mount 400. In this embodiment, the camera microcomputer 205 and the lens microcomputer 111 communicate by a three-wire clock synchronous serial communication method. The communication method is not limited to this example, and another communication method may be adopted. For example, the camera microcomputer 205 and the lens microcomputer 111 may communicate with each other by the asynchronous serial communication method.

Explanation of Communication

A description will be given of the three-wire clock synchronous serial communication method. A clock signal LCLK is sent from the camera microcomputer 205 as a communication master to the lens microcomputer 111 as a slave. A communication signal DCL from the camera microcomputer 205 to the lens microcomputer 111 includes a control command, a transmission request command, and the like. A data signal DLC from the lens microcomputer 111 to the camera microcomputer 205 includes lens data and the like transmitted in synchronization with the clock signal. The camera microcomputer 205 and the lens microcomputer 111 communicate with each other by a full duplex communication method in which the transmission and the reception are performed mutually and simultaneously in synchronization with the common clock signal LCLK.

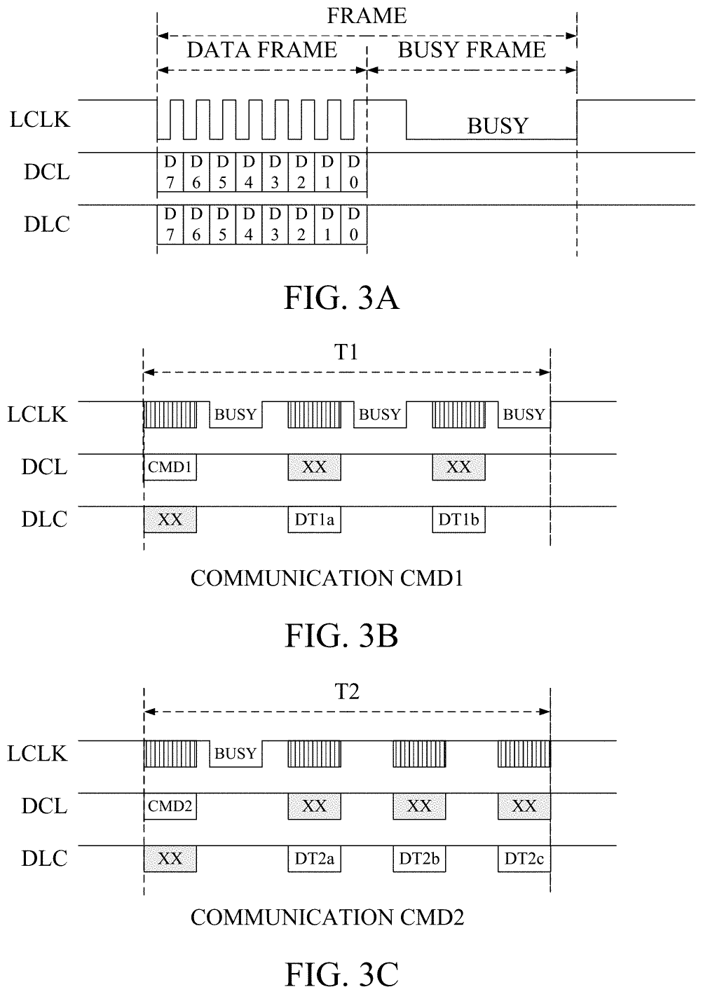

FIGS. 3A to 3C illustrate a waveform of the communication signal exchanged between the camera microcomputer 205 and the lens microcomputer 111. A communication protocol is a procedure for this exchange.

FIG. 3A illustrates a one-frame waveform of a communication signal, which is the smallest communication unit. First, the camera microcomputer 205 outputs the clock signal LCLK having eight cycles of pulses as a set, and transmits the communication signal DCL to the lens microcomputer 111 in synchronization with the clock signal LCLK. At the same time, the camera microcomputer 205 receives the data signal DLC output from the lens microcomputer 111 in synchronization with the clock signal LCLK. In this way, one-byte (eight-bit) data is transmitted and received between the camera microcomputer 205 and the lens microcomputer 111 in synchronization with a set of clock signals LCLK. This one-byte data transmission/reception period will be called a data frame. After the data frame, a communication suspension period is inserted by communication standby request information (simply referred to as communication standby request hereinafter) BUSY notified from the lens microcomputer 111 to the camera microcomputer 205. This communication suspension period will be referred to as a BUSY frame. A communication unit consisting of a data frame and a BUSY frame will be called one frame.

FIG. 3B illustrates a waveform of a communication signal composed of three frames in which the camera microcomputer 205 transmits a command CMD1 to the lens microcomputer 111 and receives corresponding two-byte lens data DT1a and DT1b. Between the camera microcomputer 205 and the lens microcomputer 111, the type and the number of bytes of lens data DT corresponding to each of a plurality of types of command CMDs are determined in advance.

In the first frame, the camera microcomputer 205 transmits the clock signal LCLK and the command CMD1 corresponding to the lens data DT1a and DT1b requesting transmission as the communication signal DCL. The data signal DLC in this frame is treated as invalid data.

Next, the camera microcomputer 205 outputs the clock signal LCLK for eight cycles, and then switches the communication terminal state on the camera body 200 side from the output format to the input format. After the switching of the communication terminal state on the camera body 200 side is completed, the lens microcomputer 111 switches the communication terminal state on the interchangeable lens 100 side from the input format to the output format. Then, the lens microcomputer 111 sets the signal level of the clock signal LCLK to LOW in order to notify the camera microcomputer 205 of the communication standby request BUSY. The camera microcomputer 205 maintains the communication terminal state in the input format during the period when the communication standby request BUSY is notified, and suspends the communication to the lens microcomputer 111.

The lens microcomputer 111 generates the lens data DT1a corresponding to the command CMD1 during the notification period of the communication standby request BUSY. After the preparation for transmitting the data signal DLC of the next frame is completed, the lens microcomputer 111 sets the signal level of the clock signal LCLK to HIGH in order to notify the camera microcomputer 205 of the cancellation of the communication standby request BUSY. When the camera microcomputer 205 recognizes the cancellation of the communication standby request BUSY, it receives the lens data DT1a from the lens microcomputer 111 by transmitting the one-frame clock signal LCLK to the lens microcomputer 111. Similarly, the camera microcomputer 205 receives the lens data DT1b.

FIG. 3C illustrates a waveform of a communication signal composed of four frames in which the camera microcomputer 205 transmits a command CMD2 to the lens microcomputer 111 and receives corresponding three-byte lens data DT2a, DT2b, and DT2c. The lens microcomputer 111 notifies the camera microcomputer 205 of the communication standby request BUSY in the first frame, but does not notify the camera microcomputer 205 of the communication standby request BUSY in the second to fourth frames. This configuration can shorten a period between frames.

Explanation of Mf Dedicated Area

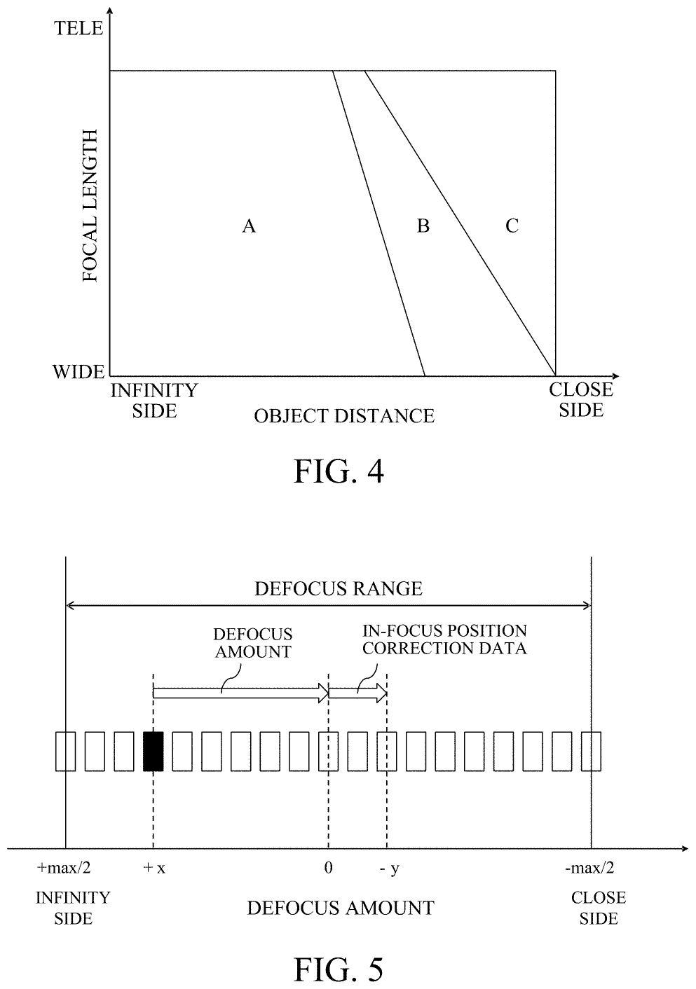

FIG. 4 illustrates a movable range of the focus lens 104. The movable range of the focus lens 104 is predetermined according to the position of the magnification varying lens 102, that is, the focal length.

A focus area A (first area) is an area in which the detecting reliability of the in-focus position by the AF that causes the camera body 200 to provide automatic focusing. In the focus area A, the focus lens 104 is movable in both the AF and the MF. A focus area B (second area) is an area in which the detecting reliability of the in-focus position by the AF is low. In the focus area B, the focus lens 104 cannot move in the AF, but can move in the MF. The detecting reliability of the in-focus position by the AF is low, for example, when the F-number becomes large and a sufficient light amount cannot be taken into the focus detecting sensor in the camera body 200, or when the image quality is so low that the focus detecting sensor cannot provide a reliable focus detecting calculation. A focus area C is an area in which the focus lens 104 cannot move in each of the AF and the MF.

Therefore, the lens microcomputer 111 drives and controls the focus lens 104 in the focus area A when attempting the AF, and drives and controls the focus lens 104 in the area obtained by combining the focus areas A and B when attempting the MF.

In this embodiment, when the AF is performed for the object having the object distance corresponding to the focus area Awhile the focus lens 104 is located in the focus area B, the focus position correction data described later is changed. Thereby, the focus lens 104 can be forcibly moved from the focus area B to the focus area A based on a moving instruction of the focus lens 104 from the camera microcomputer 205, and the AF can be smoothly started in the focus area A.

The position in the focus area A after the movement of the focus lens 104 may be set to a position in the focus area A closest to the focus area B for efficiency purposes in order to reduce an unnecessary movement, but any position may be used in the focus area A.

Explanation of In-Focus Position Correction

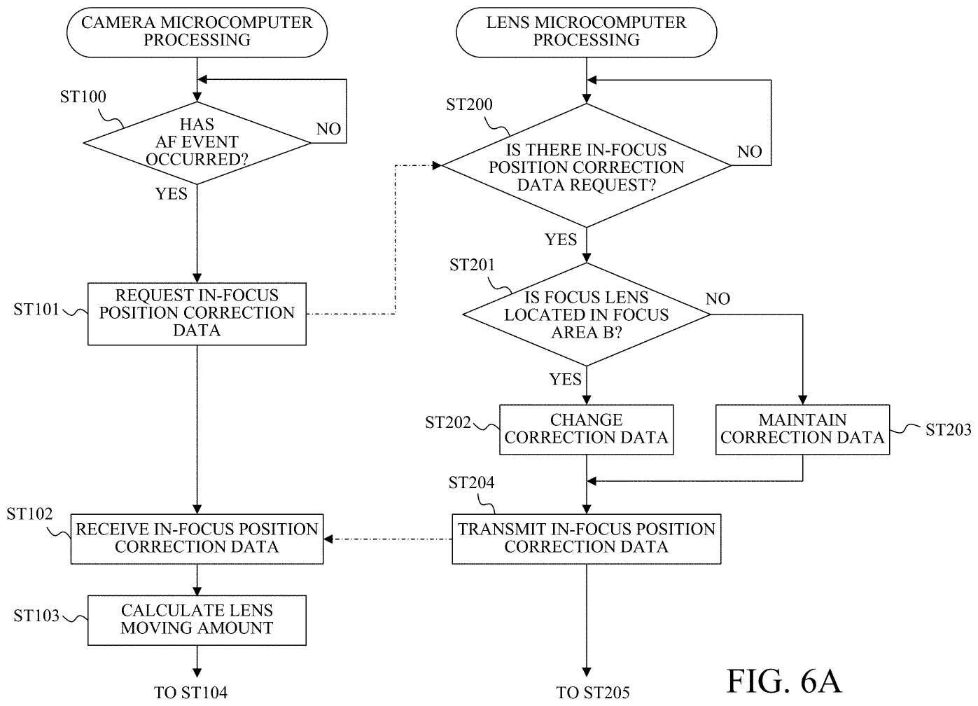

Referring now to FIG. 5, a description will be given of a configuration for calculating the in-focus position in the camera body 200. FIG. 5 illustrates a relationship between a defocus amount detected by the focus detecting sensor in the camera body 200 and the in-focus position correction data transmitted from the interchangeable lens 100.

Usually, in the focus detecting sensor, a defocus range detectable in each of the infinity side direction and the close side direction is set while the in-focus position is set to a defocus amount of zero. The camera microcomputer 205 sends an instruction to move the focus lens 104 to the lens microcomputer 111 based on the detected defocus amount, and controls the defocus amount to be zero. When the focus detecting sensor cannot detect the defocus amount, the camera microcomputer 205 causes the lens microcomputer 111 to perform so-called search driving in which the focus lens 104 is driven by the maximum amount in the infinity side direction or the close side direction.

There is a slight deviation between the defocus amount detected by the focus detecting sensor and the best focus position error that is actually captured, due to the influence of the spherical aberration of the interchangeable lens 100 and the like. In order to correct this deviation, the lens microcomputer 111 transmits the in-focus position correction data to the camera microcomputer 205. The camera microcomputer 205 corrects the defocus amount detected by the focus detecting sensor with the received focus position correction data, and controls driving of the focus lens 104. The in-focus position correction data may be stored in the interchangeable lens 100 or acquired from an external device such as a server.

FIG. 5 illustrates an example in which the detectable defocus amount is up to ±max/2, the defocus amount detected by the focus detecting sensor is +x, and the focus position correction data transmitted by the lens microcomputer 111 is −y. In this case, the camera microcomputer 205 calculates a moving amount of the focus lens 104 corresponding to the defocus amount −x−y, and instructs the lens microcomputer 111 to move the focus lens 104.

For example, when the defocus amount detected by the focus detecting sensor is +x and the in-focus position correction data transmitted by the lens microcomputer 111 is −x, the camera microcomputer 205 calculates a moving amount of the focus lens 104 corresponding to the defocus amount −x+x. In this case, since the moving amount is calculated to be zero, the current position of the focus lens 104 is determined to be the in-focus position, and the camera microcomputer 205 does not instruct the lens microcomputer 111 to move the focus lens 104.

The lens microcomputer 111 cannot know a defocus amount detected by the focus detecting sensor. Regardless of the defocus amount having a value within ±max/2, a value larger than ±max/2 may be sent as the in-focus position correction data in order for the camera microcomputer 205 to reliably instruct the lens microcomputer 111 to move the focus lens 104. Thereby, the camera microcomputer 205 can reliably instruct the lens microcomputer 111 to move the focus lens 104 regardless of the defocus amount detected by the focus detecting sensor. A value which the camera microcomputer 205 actually determines to be in focus has a range, and generally, if it is within a depth of focus, it is determined to be in focus. Therefore, a value larger than ±(max+depth of focus)/2 may be transmitted.

Explanation of Operation Flow

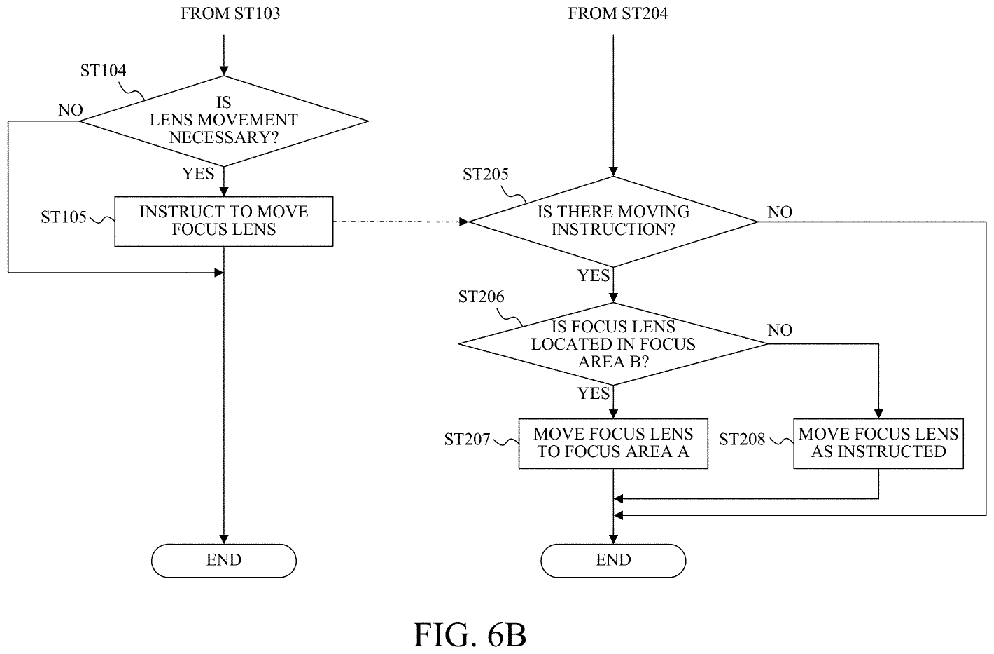

Referring now to FIGS. 6A and 6B, a description will be given of an operation flow of reset (or recovery) operation processing of the focus lens 104 performed between the camera microcomputer 205 and the lens microcomputer 111. FIGS. 6A and 6B illustrate the operation flow of reset operation processing of the focus lens 104 performed between the camera microcomputer 205 and the lens microcomputer 111. Each microcomputer performs the reset operation processing according to the operation flow in FIGS. 6A and 6B according to its own computer program. The communication command is transmitted and received according to the communication method illustrated in FIGS. 3A to 3C. In this flow, the focus lens 104 is located in any of the focus areas A and B described with reference to FIG. 4.

In the step ST100, the camera microcomputer 205 determines whether or not an AF event has occurred in the camera body 200 due to the user operation or the like. If the event occurs, the flow proceeds to the step ST101. If no event has occurred, the step ST100 is repeated.

In the step ST101, the camera microcomputer 205 transmits a signal requesting the in-focus position correction data to the lens microcomputer 111. In the step ST200, the lens microcomputer 111 determines whether or not the signal requesting the in-focus position correction data has been received from the camera microcomputer 205. When the signal requesting the in-focus position correction data is received, the flow proceeds to the step ST201, otherwise the step ST200 is repeated.

In the step ST201, the lens microcomputer 111 determines whether or not the focus lens 104 is located in the focus area B. When the focus lens 104 is located in the focus area B, the flow proceeds to the step ST202. When the focus lens 104 is located outside the focus area B, that is, when the focus lens 104 is located in the focus area A, the flow proceeds to the step ST203. Whether or not the boundary between the focus areas A and B is included in the focus area B can be arbitrarily set.

In the step ST202, the lens microcomputer 111 changes the in-focus position correction data to a value (second correction data) different from the original value (first correction data). In this embodiment, the value is changed to a value larger than half a value of a sum of the defocus range and the depth of focus.

In the step ST203, the lens microcomputer 111 does not change the in-focus position correction data (maintains the original value).

In the step ST204, the lens microcomputer 111 transmits the in-focus position correction data to the camera microcomputer 205. In the step ST102, the camera microcomputer 205 receives the in-focus position correction data from the lens microcomputer 111.

In the step ST103, the camera microcomputer 205 calculates a moving amount of the focus lens 104 using the defocus amount detected by the focus detecting sensor and the in-focus position correction data.

In the step ST104, the camera microcomputer 205 determines whether or not the focus lens 104 needs to be moved by using the moving amount of the focus lens 104 calculated in the step ST103. If the movement is required, the flow proceeds to the step ST105, and if the movement is not required, the flow of the camera microcomputer 205 ends. The movement of the focus lens 104 is unnecessary, for example, where the moving amount of the focus lens 104 calculated in the step ST103 is zero, or where the moving amount is included in the depth of focus determined to be in focus.

In the step ST105, the camera microcomputer 205 instructs the lens microcomputer 111 to move the focus lens 104.

In the step ST205, the lens microcomputer 111 determines whether or not the moving instruction of the focus lens 104 has been received from the camera microcomputer 205. When the moving instruction is received, the flow proceeds to the step ST206, otherwise the flow of the lens microcomputer 111 ends.

In the step ST206, the lens microcomputer 111 determines whether or not the focus lens 104 is located in the focus area B. If the focus lens 104 is located in the focus area B, the flow proceeds to the step ST207, otherwise the flow proceeds to the step ST208.

In the step ST207, the lens microcomputer 111 moves the focus lens 104 to the focus area A. The position in the focus area A after the focus lens 104 moves may be set to the position in the focus area A closest to the focus area B for efficiency purposes in order to reduce an unnecessary movement, but it may be another position as long as it is located in the focus area A.

In the step ST208, the lens microcomputer 111 moves the focus lens 104 as instructed by the camera microcomputer 205.

As described above, in this embodiment, when the lens microcomputer 111 determines that the focus lens 104 is located in the focus area B, the value of the in-focus position correction data transmitted to the camera microcomputer 205 is changed to a value different from the original value. The value to be changed is a value equal to or larger than a value obtained by dividing by 2 a value that is a sum of the maximum defocus amount detectable by the focus detecting sensor and the depth of focus determined to be in focus. Then, the lens microcomputer 111 moves the focus lens 104 to the focus area A regardless of the content of the moving instruction of the focus lens 104 received from the camera microcomputer 205. Thereby, even when the focus lens 104 is located in the focus area B, the focus lens 104 can be moved to the focus area A without any arduous operations, and the AF operation in the focus area A is ready to start smoothly.

In this embodiment, the focus lens 104 is driven and controlled by the camera microcomputer 205, but may be driven by the lens microcomputer 111. In this case, the lens microcomputer 111 calculates the driving amount of the focus lens 104 using the in-focus position correction data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-089680, filed on May 22, 2020, which is hereby incorporated by reference herein in its entirety.

What is claimed is:

1. A lens apparatus that is attachable to, detachable from, and communicable with the image pickup apparatus, the lens apparatus comprising:
a focus lens configured to provide focusing;
a driver configured to drive the focus lens; and
at least one processor or circuit configured to execute a plurality of tasks configured:
to acquire first correction data for correcting an in-focus position;
to maintain the first correction data when the focus lens is located in a first area where detecting reliability of the in-focus position by autofocus is high; and
to change the first correction data to second correction data when the focus lens is located in a second area where the detecting reliability of the in-focus position by the autofocus is low.

2. The lens apparatus according to claim 1, wherein the plurality of tasks are further configured:
to transmit the first correction data to the image pickup apparatus when the focus lens is located in the first area; and
to transmit the second correction data to the image pickup apparatus when the focus lens is located in the second area.

3. The lens apparatus according to claim 1, wherein the second correction data has a value larger than half a defocus range detectable by the autofocus.

4. The lens apparatus according to claim 1, wherein the second correction data has a value larger than half a value that is a sum of a defocus range detectable by the autofocus and a depth of focus.

5. The lens apparatus according to claim 1, wherein the plurality of tasks are further configured to instruct the driver to move the focus lens to the first area, when the focus lens is located in the second area and the lens apparatus receives a signal relating to driving of the focus lens based on the second correction data from the image pickup apparatus.

6. The lens apparatus according to claim 1, wherein the plurality of tasks are further configured, when the focus lens is located in the second area, to generate a signal relating to driving of the focus lens using the second correction data and to instruct the driver to move the focus lens to the first area.

7. The lens apparatus according to claim 1, wherein the first area is an area that can be in focus by autofocusing and manual focusing, and the second area is an area that can be in focus by manual focusing.

8. An image pickup apparatus attachable to, detachable from, and communicable with a lens apparatus that includes a focus lens configured to provide focusing, a driver configured to drive the focus lens, and at least one processor or circuit configured to execute a plurality of tasks configured to acquire first correction data for correcting an in-focus position, to maintain the first correction data when the focus lens is located in a first area where detecting reliability of the in-focus position by autofocus is high, and to change the first correction data to second correction data when the focus lens is located in a second area where the detecting reliability of the in-focus position by the autofocus is low, the image pickup apparatus comprising at least one processor or circuit configured to execute a plurality of tasks configured:
to generate a signal relating to driving of the focus lens based on the first correction data when the first correction data is acquired from the lens apparatus; and
to generate a signal relating to driving the focus lens based on the second correction data when the second correction data is acquired from the lens apparatus.

9. A camera system comprising:
an image pickup apparatus; and
a lens apparatus attachable to, detachable from, and communicable with the image pickup apparatus,
wherein the lens apparatus includes:
a focus lens configured to provide focusing;
a driver configured to drive the focus lens; and
at least one processor or circuit configured to execute a plurality of tasks configured:
to acquire first correction data for correcting an in-focus position;
to maintain the first correction data when the focus lens is located in a first area where detecting reliability of the in-focus position by autofocus is high; and
to change the first correction data to second correction data when the focus lens is located in a second area where the detecting reliability of the in-focus position by the autofocus is low,
wherein the image pickup apparatus includes at least one processor or circuit configured to execute a plurality of tasks configured:
to generate a signal relating to driving of the focus lens based on the first correction data when the first correction data is acquired from the lens apparatus; and
to generate a signal relating to driving the focus lens based on the second correction data, when the second correction data is acquired from the lens apparatus.
